(19) United States
(12) Patent Application Publication
(10) Pub. No.: US 2016/0270458 A1
(43) Pub. Date: Sep. 22, 2016

(54) COOLING BACKPACK APPARATUS

(71) Applicant: Mean Green Products, LLC, Hamilton, OH (US)

(72) Inventors: Joseph C. Conrad, Okeana, OH (US); Matthew C. Conrad, Okeana, OH (US)

(73) Assignee: Mean Green Products, LLC, Hamilton, OH (US)

(21) Appl. No.: 15/067,313

(22) Filed: Mar. 11, 2016

Related U.S. Application Data
(60) Provisional application No. 62/133,564, filed on Mar. 16, 2015.

(51) Int. Cl. A41D 13/002; H01M 10/0565; H01M 2/20; H01M 10/0525; A45F 3/14; H01M 2/10

(52) U.S. Cl. CPC A41D 13/0025; A45F 3/14; H01M 2/1005; H01M 2/1022; H01M 2/20; H01M 10/0525; H01M 10/0565; A45F 2003/003

(57) ABSTRACT

A cooling backpack apparatus includes a frame secured to a harness with the harness configured for removable securement to an operator. A battery pack having a battery pack enclosure encases a plurality of battery cells. The battery pack is removably or permanently secured at least indirectly to the frame. A cooling fan is secured to the frame and electrically connected to the battery pack. An air input port receives air into the cooling fan, and an air output port permits exit of forced air generated by the cooling fan directly to the operator wearing the harness. An air chute is provided for guiding the flow of air from the air input port to the air output port.

### CROSS-REFERENCE TO RELATED APPLICATIONS

This application claims priority from U.S. Provisional Patent Application Ser. No. 62/133,564 filed on Mar. 16, 2015, of which is incorporated herein by reference in its entirety.

### RELATED FIELD

The present invention relates generally to the field of outdoor power equipment, and specifically to battery backpacks for powering electric lawn and garden tools.

### BACKGROUND

In general, backpack batteries are becoming well known, especially in the commercial turf care industry. Backpack batteries are typically used as a long run time solution for electric hand held power equipment such as string trimmers, hedgers, pole saws, and metal blade edgers. Accordingly, most such backpack batteries are large, expensive, heavy, and uncomfortable for the operator to carry on their backs throughout the work day. Such backpack batteries are often very hot for the operator to wear due to excessive battery operating temperatures when under a load and the extra weight of the heavy backpack battery that the operator must burden. A typical backpack battery will consist of an enclosure to secure the energy source such as cylindrical lithium batteries, a support for mounting the enclosure, padding between the operator and enclosure support, a strap harness, a flexible power cord permanently attached to the battery enclosure at one end and a battery adapter on the other end of the cord to attached to the handheld tool. Such backpack batteries generally supply required power to the tools they are designed to operate, however, these large backpack batteries cause operator fatigue due to their size and weight of about 18-20 pounds and cause operator discomfort from the heat of the cylindrical batteries and perspiration trapped between the operator's back and the backpack harness and support. In a commercial setting, use of such backpack batteries can be all day long, operators can feel sick from the overexposure to the heat, and feel fatigue from the work of carrying the heavy backpack battery. Most operators will do anything they can to avoid using the backpack batteries, in large part because of the heat from the battery and heat from the operator's body that builds up between the user's back and the backpack battery, which leads to substantial discomfort.

Such backpack batteries are also only useful for a single battery charge and then must be removed and re-charged, which likely takes several hours before the backpack battery to be used again. This frequently leaves the operator no choice except to purchase another expensive complete backpack battery to use while the first backpack battery is being charged. When using a power cord for charging, the power cords are frequently scraped, pulled, and cut from surrounding debris which can lead to the need for frequent power cord replacement. Most power cord replacement is both difficult and expensive due to need for skilled technicians for repair of the backpack battery and the added expense of replacing the tool adapter along with the power cord.

An attempt at a solution to cool the battery of a backpack battery has been addressed in U.S. Pat. Publ. No. 2015/0050532 “Battery pack system”. This patent addresses the issue of the excessive heat that is generated by the battery cells mounted in the enclosure on a backpack. Details of this patent describe the method of a battery pack constructed with voids between cylindrical battery cells used for moving air around the battery cells and expelling the now heated air away from the operator. As airflow is limited to the interior of the battery pack, there remains substantial heat generated between the operator's back and the battery support regardless of the battery cell temperature, so the operator is still hot and uncomfortable. In addition, air expelled from the interior of a battery pack can be of sufficiently high temperature so as to be unsuitable for expulsion on an operator.

### BRIEF SUMMARY

In at least some embodiments, a cooling backpack apparatus is disclosed that includes a frame secured to a harness, the harness configured for removable securement to an operator, a battery pack having a battery pack enclosure that encases a plurality of battery cells, wherein the battery pack is at least one of removably and permanently secured at least indirectly to the frame, a cooling fan secured to the frame and electrically connected to the battery pack, an air input port for receiving air into the cooling fan, an air output port for expelling forced air generated by the cooling fan directly to the operator wearing the harness; and an air chute for guiding the flow of air from the air input port to the air output port. Other embodiments, aspects, features, objectives, and advantages will be understood and appreciated upon a full reading of the detailed description and the claims that follow.

### BRIEF DESCRIPTION OF THE DRAWINGS

Embodiments of the cooling backpack apparatus are disclosed with reference to the accompanying drawings and are for illustrative purposes only. The cooling backpack apparatus is not limited in its application to the details of construction or the arrangement of the components illustrated in the drawings. The cooling backpack apparatus is capable of other embodiments or of being practiced or carried out in other various ways. In the drawings:

FIG. 1 is a top perspective view of an exemplary embodiment of a cooling backpack apparatus with an exemplary power tool secured thereto;

FIG. 2 is a front perspective view of the cooling backpack apparatus;

FIG. 3 is a rear perspective view of the cooling backpack apparatus;

FIG. 4 is a rear elevation view of the cooling backpack apparatus;

FIG. 5 is an exploded rear perspective view of the cooling backpack apparatus;

FIG. 6 is an exploded front perspective view of the cooling backpack apparatus;

FIG. 7 is a rear perspective view of the cooling backpack apparatus of FIG. 1 with various components removed for illustrative purposes; and

FIG. 8 is a sectional view taken along 8-8 of FIG. 4 with the battery removed.

### DETAILED DESCRIPTION

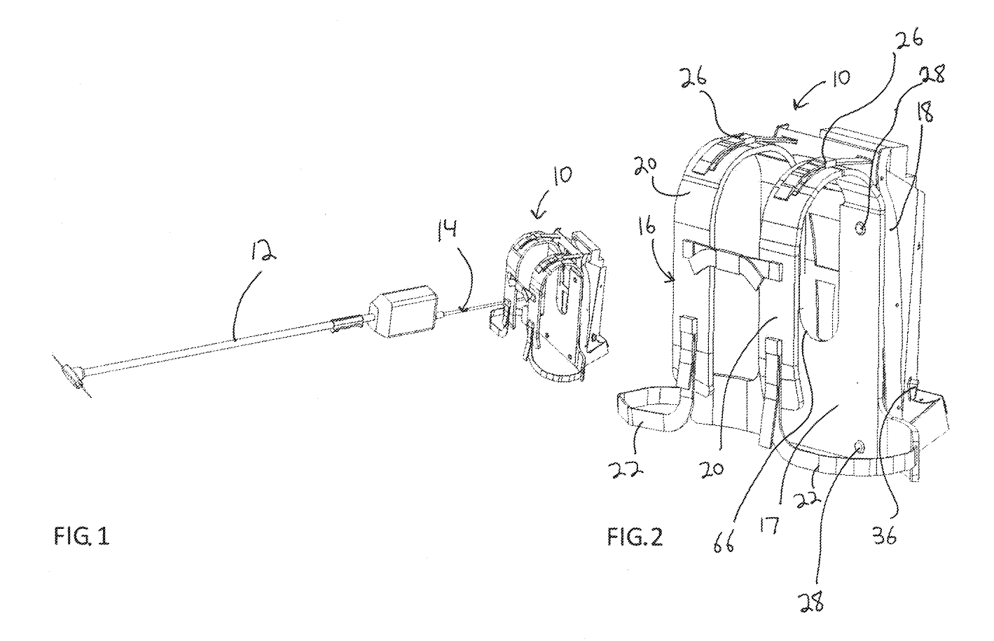

Referring to FIG. 1, an exemplary cooling backpack apparatus 10 is illustrated that can be connected to an exemplary lawn care power tool 12 by a power cord 14 and provide cooling air to an operator. The power tool 12 can be any one of numerous types of electric commercial power equipment used for landscaping, for example, string trimmers, hedge trimmers, pruning saws, brooms, edgers, blowers, pruning shears, etc. The apparatus 10 is configured to be worn by an operator to provide mobility during the performance of landscaping activities. In this manner, an operator is not restrained by electrical cords, or bulky riding and push-type devices. In addition, the apparatus 10 is designed to allow the use of the power tool 12 for extended periods of time on a single battery charge while providing cooling air to the body of an operator that is wearing the apparatus 10. The apparatus 10 can be used to provide cooling air to an operator even when a power tool is not attached or otherwise being operated. The expulsion of cooling air from the apparatus 10 serves to cool the operator's back by evaporating any moisture from perspiration on the operator's back. Providing cooling air to the body of an operator reduces fatigue on the operator allowing for longer periods of operation of the apparatus 10.

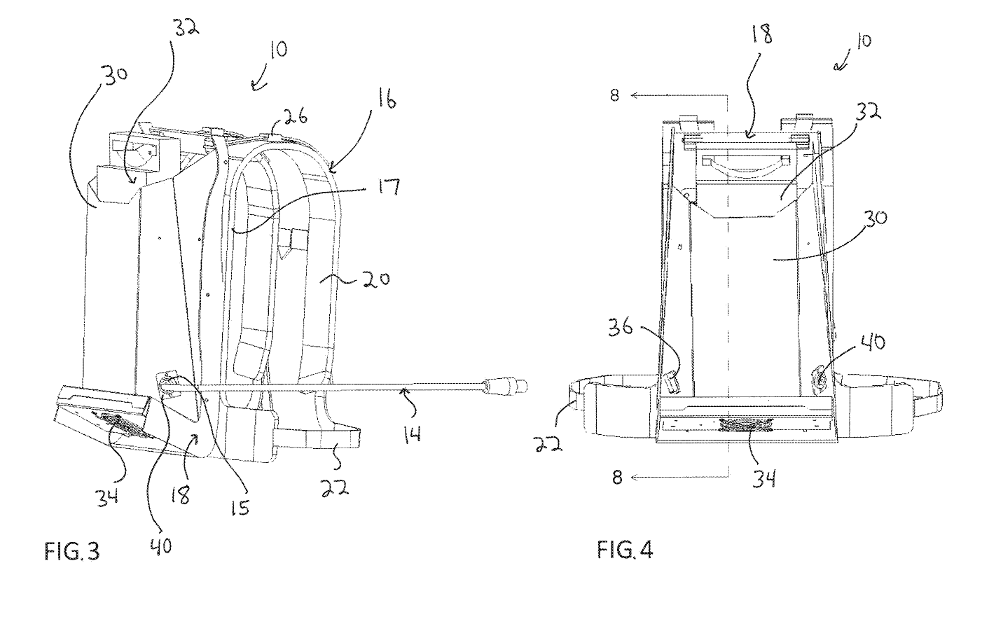

While traditional gasoline power equipment is noisy, uses fuel, oil, filters, belts, and emits toxic fumes and pollutants, the apparatus 10 can be powered by clean, zero/low emission battery power and requires minimal maintenance. The apparatus 10 is easy to use since it requires only the attachment of a plug 15 (FIG. 3) on the power cord 14 of the power tool 12 to begin operations, in contrast to a gasoline powered power tool that requires priming, choking, and warming up before it is functional for operation.

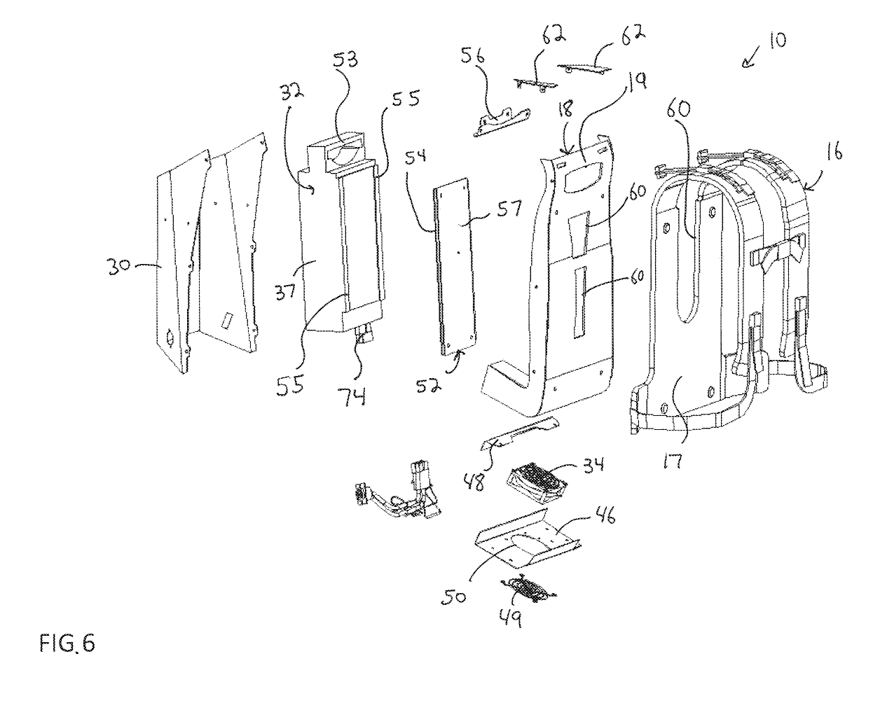

FIG. 2 provides a front perspective view of the apparatus 10, which includes a harness 16 secured to a frame 18. The harness 16 includes a plurality of straps secured to a backplate 17. The straps can include shoulder straps 20, waist straps 22, etc., each suitable to assist with removably securing the apparatus 10 to an operator. The harness 16 can be manufactured from a variety of durable natural or synthetic materials. The frame 18 is secured to the harness 16 using a plurality of fasteners, which can include frame straps 26 tethered to the shoulder straps 20, rivets 28 fastened to the backplate 17 and the frame 18, or other types of suitable fasteners. The frame 18 can be a rigid or semi-rigid structure that supports various other components, as described below. In addition, the frame 18 can include an ergonomic design to follow the contour of an operator's back. The frame can include a handle 19 (FIG. 6) for convenient transportation of the apparatus 10.

Referring to FIG. 3, a rear perspective view of the apparatus 10 is provided that illustrates a shroud 30 secured to the frame 18 and a power source, namely, a battery pack 32 utilized to provide power to a cooling fan 34 and the power tool 12. Power from the battery pack 32 to the fan 34 can be controlled by an ON/OFF fan switch 36 (FIG. 2), and power to the power tool 12 can be accessed by plugging the power cord 14 into a power port 40. The fan switch 36 can be any style of toggle, rocker, or proximity switch (used to sense an operator when the apparatus 10 is worn), including a variable speed switch to control the velocity of the cooling air provided by the fan 34. The fan switch 36 can be mounted in numerous locations on the apparatus 10.

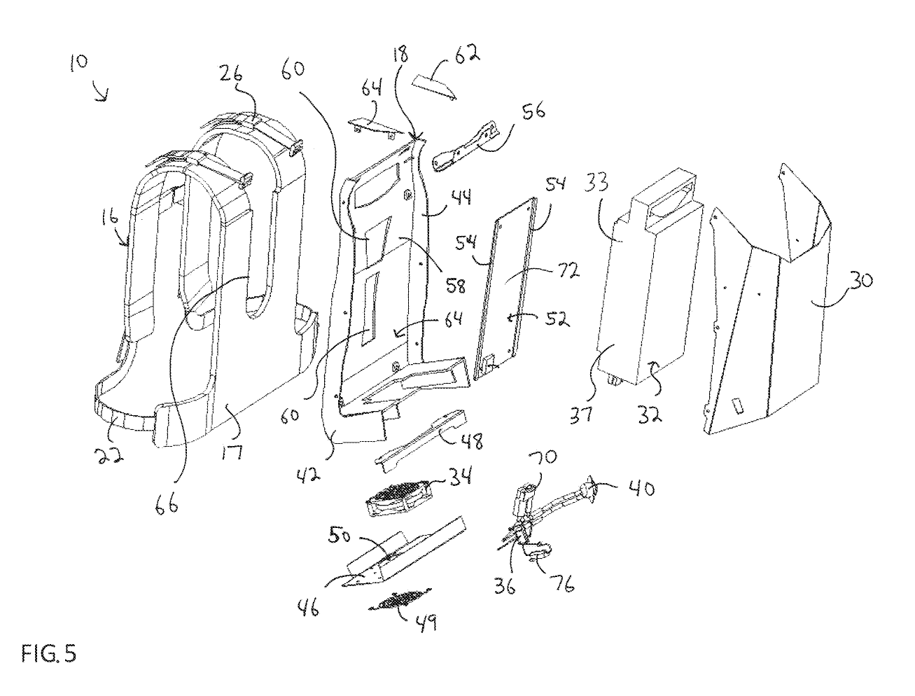

The battery pack 32 further includes a battery pack enclosure 33 (FIG. 5) for encasing any one of various battery cell (not shown) configurations to provide a desired voltage and current level. The battery pack enclosure 33 further includes an exterior surface 37 (FIG. 5). The battery pack 32 can be rechargeable and include any one of various battery types, such as lead acid, lithium polymer, etc. In at least some embodiments, the battery pack 32 is capable of maintaining a near constant voltage for the duration of its state of charge. In at least some embodiments, other types of power sources can be used in place of or in addition to the battery pack 32. The battery pack 32 can be permanently secured or removably attached to the frame 18, as discussed in detail below. FIG. 4 illustrates a rear elevation view of the apparatus 10.

Referring to FIGS. 5 and 6, exploded rear and front perspective views of the apparatus 10 are provided. As shown, the frame 18 includes a frame lower portion 42 and a frame upper portion 44. The fan 34 is secured to a fan plate 46, which along with a fan plate bar 48 and a fan blade guard 49, is secured to the frame lower portion 42. The fan plate 46 provides an air input port 50 for receiving air that is exterior to the apparatus 10 into the fan 34. A mounting plate 52 is also provided to serve as a mounting point for the battery pack 32. The mounting plate 52 is secured to the frame upper portion 44 and in at least some embodiments, can include slide rails 54 configured to matingly interface with the battery pack enclosure 33. The battery pack 32 can include mating battery rails 55 that engage the slide rails 54 during a sliding engagement to secure the battery pack 32 to the frame 18 when a removable battery pack 32 is utilized. A battery pack handle 53 can be integrally formed with or secured to the battery pack 32 for convenient transportation. A fixed internal battery pack can also be utilized.

In at least some embodiments, the mounting plate 52 can be secured to a mounting plate bar 56, which in turn is secured to the frame upper portion 44. The mounting plate bar 56 provides an offset gap 51 (FIG. 8) for the mounting plate 52, such that when the mounting plate 52 is secured to the frame upper portion 44, at least a portion of the mounting plate back surface 57 does not sit flush with or does not contact a frame back surface 58 of the frame upper portion 44, thereby allowing a flow of air around the mounting plate 52 and through a plurality of air output ports 60 in the frame upper portion 44. The air output ports 60 can be formed in various sizes and shapes, as well as have different locations and quantities. To assist with directing air flow, a plurality of deflecting portions 62 are provided that at least partially direct the flow of air towards the frame back surface 58. In at least some embodiments, the deflecting portions 62 include a pair of planar wings, while in other embodiments, an extended single substantially planar piece can be utilized to achieve the same purpose.

An air chute 64 permits air to pass through the apparatus 10 and is formed by various components situated between the air input port 50 and the air output ports 60. More particularly, and in at least some embodiments, the air chute 64 is formed by the combination of the shroud 30, the fan plate 46, the deflecting portions 62, the exterior surface 37 of the battery pack enclosure 33, the mounting plate 52, and the frame back surface 58. In at least some other embodiments, one or more of the aforementioned components can be omitted and/or other components or portions of components can be added to achieve the function of directing air between the air input port 50 and the air output ports 60. Air that passes through the air chute 64 and exits the air output ports 60 is passed through a backplate opening 66 in the harness 16 to provide cooling air to the operator. Since the air chute 64 can include exterior surface 37 of the battery pack enclosure 33, the battery can also be cooled via the passage of air around the battery pack 32, thereby increasing the life of the battery pack 32. Although the air output ports 60 are shown positioned to pass air through the frame upper portion 44, the air output ports 60 can be positioned in various other locations on the apparatus 10. In addition, the air chute 64 can include one or more additional ducts (not shown) to route the flow of air to other portions of an operator's body. Likewise, the air input port 50 can be positioned in various other locations on the apparatus 10 and can include one or more additional ducts (not shown). Further, additional air input ports can be provided on the apparatus 10, as well as additional fans.

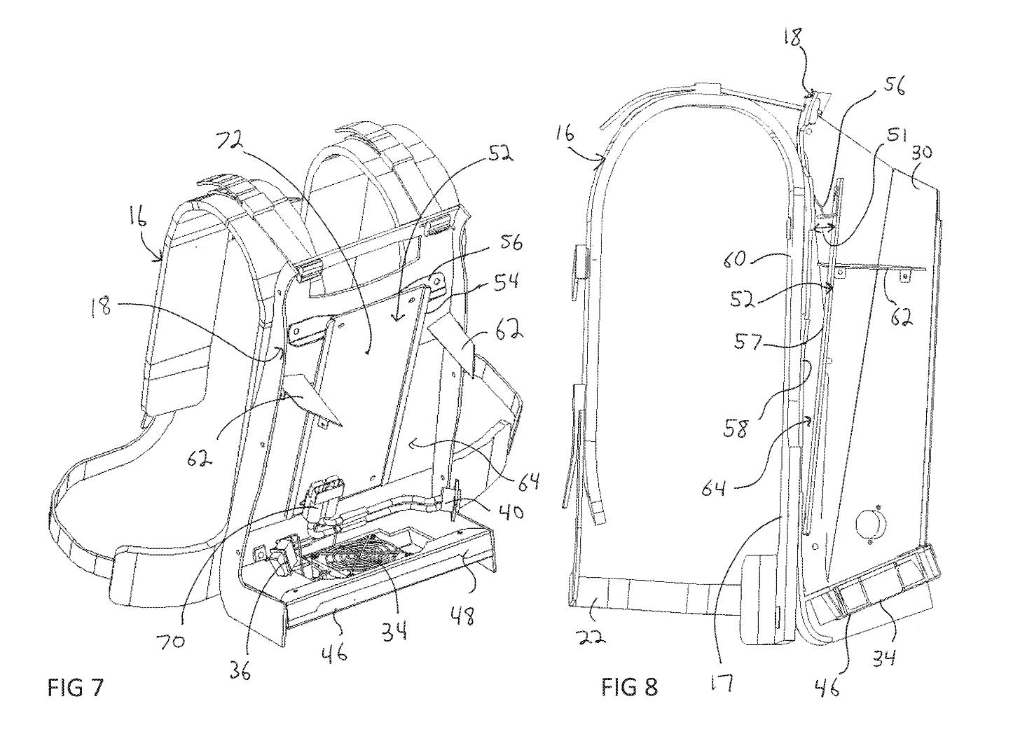

Referring now to FIG. 7, a rear perspective view of the apparatus 10 with the shroud 30 and the battery pack 32 removed is provided. Various electrical components can be included to facilitate operation of the apparatus 10, such as the aforementioned fan switch 36 and the power port 40. In at least some embodiments, power is received from the battery pack 32 via an input power connector 70 positioned adjacent a mounting plate front surface 72. The input power connector 70 can be rigidly affixed to the mounting plate front surface 72 so as to matingly engage a complimentary battery pack output connector 74 when the battery pack 32 is inserted, thereby eliminating the need for an operator to secure the connection separately from inserting the battery. This provides the operator a quick and easy method for exchanging a depleted battery pack for a charged battery pack, and allows the operator to continue utilizing the apparatus 10 without requiring extended downtime to recharge a fixed internal battery. In at least some embodiments, the input power connector 70 can be mounted in a flexible configuration allowing the operator to manually connect the battery pack 32 prior to or after installation.

The input power connector 70 is wired to both the power port 40 and the fan switch 36. The fan switch 36 in turn is wired to the fan 34. A fan resistor 76 can be wired in series between the fan switch 36 and the fan 34. Other electrical connectors, wires, and components can be utilized as necessary to achieve various other functions of the apparatus 10, including battery pack management and monitoring, temperature control components, variable speed fan operation, etc.

The aforementioned components of the apparatus 10 can be comprised of various types of materials, including but limited to metal, plastics, cloth, etc. Fasteners for securing components can include but are not limited to screws, rivets, thread, snaps, adhesives, zippers, etc. In addition, numerous components of the apparatus 10 can be comprised of various shapes, including tubular, curved, planar, angled, square, circular, rectangular, etc. It is specifically intended that the aforementioned apparatus not be limited to the embodiments and illustrations contained herein, but include modified forms of those embodiments including portions of the embodiments and combinations of elements of different embodiments as come within the scope of the following claims. Further, the use of the term “plurality” shall be understood to include one or more of a specified component.

What is claimed is:

1. A cooling backpack apparatus comprising:
a frame secured to a harness, the harness configured for removable securement to an operator;
a battery pack having a battery pack enclosure that encases a plurality of battery cells, wherein the battery pack is at least one of removably and permanently secured at least indirectly to the frame;
a cooling fan secured to the frame and electrically connected to the battery pack;
an air input port for receiving air into the cooling fan;
an air output port for expelling forced air generated by the cooling fan directly to the operator wearing the harness; and
an air chute for guiding the flow of air from the air input port to the air output port.

2. The apparatus of claim 1, wherein the air chute includes an exterior surface the battery pack enclosure.

3. The apparatus of claim 1, wherein expelled forced air is directed a backplate opening in the harness.

4. The apparatus of claim 1, further including a mounting plate secured to the frame.

5. The apparatus of claim 1, wherein the mounting plate includes a plurality of first engaging portions and the battery pack includes a plurality of second engaging portions, and wherein the battery pack is securable to the mounting plate by engagement of the first engaging portions with the second engaging portions.

6. The apparatus of claim 5, wherein the plurality of first engaging portions and the plurality of second engaging portions are rails.

7. The apparatus of claim 6, wherein the battery pack includes a battery output connector configured for mating engagement with a power input connector for providing power to the fan.

8. The apparatus of claim 7, wherein a sliding engagement of the battery pack with the mounting plate includes engagement of the battery output connector with the power input connector.

9. The apparatus of claim 1, wherein the frame includes a frame back surface and the mounting plate includes a mounting plate back surface, and wherein the air chute includes at least portions of the frame back surface and the mounting plate back surface.

10. The apparatus of claim 9, further comprising a mounting plate bar secured to the frame back surface and the mounting plate back surface by means of a securment, wherein the securement provides an offset gap between the frame back surface and the mounting plate back surface to allow the passage of forced air around the mounting plate and to the air output port.

11. The apparatus of claim 1, wherein the air chute is comprised of a shroud, a plurality of deflecting portions, the exterior surface the battery pack enclosure, the mounting plate back surface, and the back frame surface.

12. The apparatus of claim 1, wherein the battery pack includes a plurality of rechargeable lithium polymer cells.

13. The apparatus of claim 12, further comprising a fan switch and a power port, wherein the fan switch controls the fan and the power port is configured to matingly receive a power cord plug from a power tool.

14. The apparatus of claim 13, wherein the power tool includes one of a string trimmer, a hedge trimmer, a pruning saw, a broom, an edger, a blower and a pruning shears.
